(19) United States
(12) Patent Application Publication
(10) Pub. No.: US 2015/0354655 A1
(43) Pub. Date: Dec. 10, 2015

(54) SHOCK ABSORBER

(71) Applicant: KAYABA INDUSTRY CO., LTD., Minato-ku, Tokyo (JP)

(72) Inventor: Kazuhiro TANAKA, Gifu (JP)

(73) Assignee: KAYABA INDUSTRY CO., LTD., Tokyo (JP)

(21) Appl. No.: 14/761,011

(22) PCT Filed: Jan. 17, 2014
(86) PCT No.: PCT/JP2014/050849

§ 371 Date: Jul. 15, 2015

(30) Foreign Application Priority Data
Jan. 31, 2013 (JP) 2013-016881

(51) Int. Cl. F16F 9/348

(52) U.S. Cl. CPC F16F 9/3484

(57) ABSTRACT

A shock absorber includes a valve disc defining two chambers, a flow passage formed in the valve disc, the flow passage allowing communication between the two chambers, and a plurality of leaf valves formed in the shape of annular plates, the plurality of leaf valves being stacked on the valve disc to openably close an outlet of the flow passage. The leaf valve disposed on the tail end of the plurality of leaf valves stacked on the valve disc includes a rib projecting in an axial direction from one flat surface and recessed on an opposite side.

### TECHNICAL FIELD

The present invention relates to an improvement of a shock absorber.

### BACKGROUND ART

A shock absorber is used in vehicles, devices, structures and the like. Generally, such a shock absorber includes a cylinder in which working fluid is sealed, a piston in sliding contact with the inner peripheral surface of the cylinder to partition the interior of the cylinder into two chambers, a piston rod having one end part coupled to the piston and the other end side extending outwardly of the cylinder, a flow passage allowing communication between the two chambers and damping force generation means for applying resistance to the working fluid passing in the flow passage.

For example, in a shock absorber used as the one for vehicle, a cylinder is coupled to one of a vehicle body side as a vibration damping target and a wheel side as a vibration input part and a piston rod is coupled to the other of the vehicle body side and the wheel side. In such a shock absorber, a piston moves in the cylinder by the input of vibration and the working fluid in one chamber pressurized by the piston moves to the other chamber through the flow passage. Thus, the shock absorber can suppress vibration by generating a damping force resulting from the resistance of damping force generation means.

A shock absorber disclosed in JP1992-97133U includes a piston as a valve disc defining two chambers, a flow passage formed in the piston to allow communication between the two chambers, a plurality of leaf valves formed in the shape of annular plates stacked on the piston to openably close an outlet of the flow passage and an inner leaf valve and an outer leaf valve arranged substantially in the middle of these leaf valves. In the shock absorber disclosed in JP1992-97133U, the leaf valves, the inner leaf valve and the outer leaf valve serve as damping force generation means for applying resistance to working fluid passing in the flow passage.

Further, the outer leaf valve is arranged on the outer periphery of the inner leaf valve and formed to be thicker than the inner leaf valve. Thus, in the shock absorber disclosed in JP1992-97133U, a valve opening pressure of the leaf valves can be set high by applying initial deflection to the leaf valves stacked on an opposite piston side of the outer leaf valve and generate a large damping force when a piston speed is in a medium/high speed region.

### SUMMARY OF INVENTION

For such a shock absorber, there is a demand to increase the damping force when the piston speed is in the medium/high speed region without applying initial deflection to the leaf valves. In this case, it is thought to increase the number of stacked leaf valves, but it makes the assembling of the shock absorber cumbersome and makes an axial length of the stacked leaf valves as a whole longer. Thus, in such a case, it may not be possible to use the piston and the piston rod for holding the leaf valves, which piston and piston rod are used in the shock absorber as described above.

The present invention aims to provide a shock absorber capable of increasing a damping force when a piston speed is in a medium/high speed region without applying initial deflection to leaf valves and suppressing an axial length of the leaf valves as a whole.

According to one aspect of the present invention, a shock absorber includes a valve disc defining two chambers, a flow passage formed in the valve disc, the flow passage allowing communication between the two chambers, and a plurality of leaf valves formed in the shape of annular plates, the plurality of leaf valves being stacked on the valve disc to openably close an outlet of the flow passage. The leaf valve disposed on the tail end of the plurality of leaf valves stacked on the valve disc includes a rib projecting in an axial direction from one flat surface and recessed on an opposite side.

### BRIEF DESCRIPTION OF DRAWINGS

FIG. 1 is a vertical sectional view showing a piston part in a shock absorber according to an embodiment of the present invention,

FIG. 2A is a plan view showing an expansion-side leaf valve disposed on the tail end in the shock absorber according to the embodiment of the present invention,

FIG. 2B is an end view cut along a line Z1-Z1 of FIG. 2A,

FIG. 3A is a plan view showing a first modification of a rib formed on the expansion-side leaf valve disposed on the tail end in the shock absorber according to the embodiment of the present invention,

FIG. 3B is an end view cut along a line Z2-Z2 of FIG. 3A,

FIG. 4A is a plan view showing a second modification of the rib formed on the expansion-side leaf valve disposed on the tail end in the shock absorber according to the embodiment of the present invention,

FIG. 4B is an end view cut along a line Z4-Z4 of FIG. 4A,

FIG. 5A is a plan view showing a third modification of the rib formed on the expansion-side leaf valve disposed on the tail end in the shock absorber according to the embodiment of the present invention,

FIG. 5B is an end view cut along a line Z5-Z5 of FIG. 5A,

FIG. 6A is a plan view showing a fourth modification of the rib formed on the expansion-side leaf valve disposed on the tail end in the shock absorber according to the embodiment of the present invention,

FIG. 6B is an end view cut along a line Z3-Z3 of FIG. 6A,

FIG. 7A is a plan view showing a fifth modification of the rib formed on the expansion-side leaf valve disposed on the tail end in the shock absorber according to the embodiment of the present invention,

FIG. 7B shows an example of an end surface cut along a line Z6-Z6 of FIG. 7A,

FIG. 7C shows another example of the end surface cut along the line Z6-Z6 of FIG. 7A,

FIG. 8A is a plan view showing a sixth modification of the rib formed on the expansion-side leaf valve disposed on the tail end in the shock absorber according to the embodiment of the present invention,

FIG. 8B shows an example of an end surface cut along a line Z7-Z7 of FIG. 8A,

FIG. 8C shows another example of the end surface cut along the line Z7-Z7 of FIG. 8A,

FIG. 9A is a plan view showing a seventh modification of the rib formed on the expansion-side leaf valve disposed on the tail end in the shock absorber according to the embodiment of the present invention,

FIG. 9B shows an example of an end surface cut along a line Z8-Z8 of FIG. 9A, and

FIG. 9C shows another example of the end surface cut along the line Z8-Z8 of FIG. 9A.

### DESCRIPTION OF EMBODIMENT

Hereinafter, an embodiment of the present invention is described with reference to the accompanying drawings. The same reference signs denote the same or corresponding components throughout the drawings.

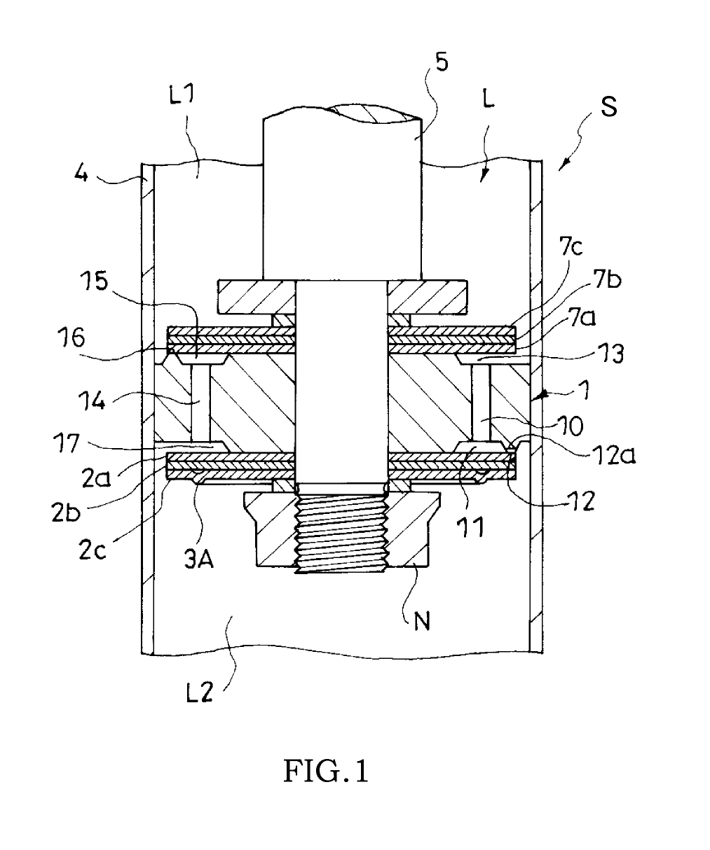

As shown in FIG. 1, a shock absorber S according to the embodiment of the present invention includes a piston 1 (valve disc) defining an expansion-side chamber L1 and a compression-side chamber L2 (two chambers), a flow passage (flow passage) 10 formed in the piston 1 and allowing communication between the expansion-side chamber L1 and the compression-side chamber L2 and a plurality of expansion-side leaf valves (leaf valves) 2a to 2c formed in the shape of annular plates stacked on the piston 1 to openably close an outlet of the expansion-side flow passage 10.

The expansion-side leaf valve (leaf valve) 2c disposed on the trail end of the expansion-side leaf valves stacked on the piston (valve disc) 1 includes a rib 3A projecting in an axial direction from one flat surface and recessed on an opposite side. That is, out of the expansion-side leaf valves stacked on the piston 1, the leaf valve 2c stacked at a most distant position from the piston 1 includes the rib 3A. As shown in FIG. 1, the rib 3A is formed to be recessed on a piston side (valve disc side) and project on an opposite piston side (opposite valve disc side) opposite to the piston.

The shock absorber S is described in detail below. The shock absorber S is an upright single-cylinder type fluid pressure shock absorber interposed between a vehicle body and a wheel of a vehicle and stores liquid such as oil, water or solution as working fluid. Since being known, the configuration of the shock absorber S is not shown in detail. The shock absorber S includes a cylinder 4 coupled to a wheel side, the piston 1 in sliding contact with the inner peripheral surface of the cylinder 4, a piston rod 5 having one end part coupled to the piston 1 by a nut N and the other end side extending outwardly of the cylinder 4 and coupled to a vehicle body side, an annular rod guide (not shown) fixed to a vehicle body side opening end part of the cylinder 4, a free piston (not shown) in sliding contact with the inner peripheral surface of the cylinder 4 on the opposite piston side and a bottom cap (not shown) for closing a wheel side opening of the cylinder 4.

The piston rod 5 penetrates through an axial central part of the rod guide and rotatably supported by the rod guide in such a manner as to be movable in the axial direction. An annular seal in sliding contact with the outer peripheral surface of the piston rod 5 is fixed to the inner periphery of the rod guide. A clearance between the rod guide and the cylinder 4 is closed by this seal.

In the cylinder 4, the working fluid is stored between the rod guide and the free piston, thereby forming a liquid chamber L. In the cylinder 4, gas is enclosed between the free piston and the bottom cap, thereby forming a gas chamber (not shown). The liquid chamber L is partitioned into two chambers by the piston 1. Out of the two chambers, the chamber on a piston rod side (upper side in FIG. 1) is the expansion-side chamber L1 and the one on an opposite piston rod side (lower side in FIG. 1) opposite to the piston rod is the compression-side chamber L2.

When the piston rod 5 is retracted from the cylinder 4, i.e. during the expansion of the shock absorber S, a cylinder interior volume increases by a volume of a retracted part of the piston rod, wherefore the free piston moves to the vehicle body side to enlarge a volume of the gas chamber. When the piston rod 5 is inserted into the cylinder 4, i.e. during the compression of the shock absorber S, the cylinder interior volume decreases by a volume of an inserted part of the piston rod, wherefore the free piston moves to the wheel side to reduce the volume of the gas chamber. As just described, in the present embodiment, a change of the cylinder interior volume corresponding to the volume of the retracted or inserted part of the piston rod into or from the cylinder during the expansion/compression of the shock absorber is compensated for by the unillustrated gas chamber.

The piston 1 in sliding contact with the inner peripheral surface of the cylinder 4 is a valve disc which defines the expansion-side chamber L1 and the compression-side chamber L2 as the two chambers. The piston 1 is formed with expansion-side and compression-side flow passages 10, 14 allowing communication between the expansion-side chamber L1 and the compression-side chamber L2. The piston 1 is formed with an opening window 13 connected to a starting end of the expansion-side flow passage 10, a window 15 connected to a final end of the compression-side flow passage 14 and a valve seat 16 surrounding the outer periphery of the window 15 to partition between the window 15 and the opening window 13 on an expansion-side chamber side (upper side in FIG. 1). The piston 1 is formed with an opening window 17 connected to a starting end of the compression-side flow passage 14, a window 11 connected to a final end of the expansion-side flow passage 10 and a valve seat 12 surrounding the outer periphery of the window 11 to partition between the window 11 and the opening window 17 on a compression-side chamber side (lower side in FIG. 1).

The opening window 13 on the expansion-side chamber side connected to the expansion-side flow passage 10 is open to the expansion-side chamber L1 and constantly allows communication between the expansion-side chamber L1 and the expansion-side flow passage 10. On the other hand, the opening window 17 on the compression-side chamber side connected to the compression-side flow passage 14 is open to the compression-side chamber L2 and constantly allows communication between the compression-side chamber L2 and the compression-side flow passage 14.

On the piston 1, a plurality of leaf valves 2a to 2c, 7a to 7c formed in the shape of annular plates are stacked on each of the compression-side chamber side and the expansion-side chamber side. The leaf valves stacked on the compression-side chamber side of the piston 1 are the expansion-side leaf valves 2a to 2c. The leaf valves stacked on the expansion-side chamber side of the piston 1 are compression-side leaf valves 7a to 7c. Although three expansion-side leaf valves 2a to 2c and three compression-side leaf valves 7a to 7c are provided in FIG. 1, the number of the stacked leaf valves can be appropriately changed.

A state where outer peripheral parts of the first leaf valves 2a, 7a closest to the piston out of the expansion-side and compression-side leaf valves 2a to 2c, 7a to 7c are seated on the valve seats 12, 16 is shown in FIG. 1. In this state, the expansion-side leaf valves 2a to 2c close the outlet of the expansion-side flow passage 10 and the compression-side leaf valves 7a to 7c close an outlet of the compression-side flow passage 14. When a pressure in the expansion-side chamber L1 exceeds that in the compression-side chamber L2 and a differential pressure between the two chambers reaches a valve opening pressure, outer peripheral parts of the expansion-side leaf valves 2a to 2c are deflected toward the opposite piston side and the first expansion-side leaf valve 2a is separated from the valve seat 12 to open the expansion-side flow passage 10. On the contrary, when the pressure in the compression-side chamber L2 exceeds that in the expansion-side chamber L1 and the differential pressure between the two chambers reaches the valve opening pressure, outer peripheral parts of the compression-side leaf valves 7a to 7c are deflected toward the opposite piston side and the first compression-side leaf valve 7a is separated from the valve seat 16 to open the compression-side flow passage 14.

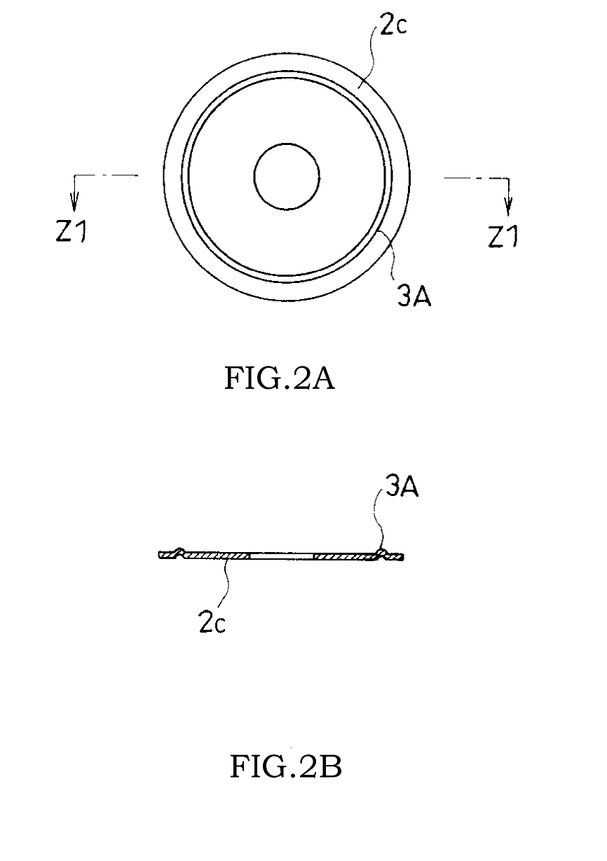

As shown in FIG. 2, the circular annular rib 3A recessed on the piston side and projecting on the opposite piston side is formed on the leaf valve 2c disposed on the tail end which is most distant from the piston 1 out of the expansion-side leaf valves 2a to 2c. In the shock absorber S, the rib 3A is formed by sandwiching a material between a pair of tools and plastically deforming the material into the shapes of the tools such as by press-working. Thus, the rib 3A can be easily formed by causing the piston side of the leaf valve 2c to be recessed and, simultaneously causing an opposite side (opposite piston side) of this part to project. As long as it is possible to cause the piston side of the leaf valve 2c to be recessed and cause the side opposite to this part to project, a rib forming method is not limited to the above one and can be appropriately selected.

The valve seat 12 on and from which the first expansion-side leaf valve 2a is seated and separated is formed with a groove 12a. Thus, an orifice is formed between the expansion-side leaf valve 2a and the groove 12a in a state where the first expansion-side leaf valve 2a is seated on the valve seat 12. Thus, the expansion-side chamber L1 and the compression-side chamber L2 constantly communicate via the orifice also in a state where the outer peripheral part of the first expansion-side leaf valve 2a is seated on the valve seat 12.

A configuration for forming the orifice is not limited to the above one and the first expansion-side leaf valve 2a may be provided with a cut and an orifice may be formed by this cut although not shown.

Next, the operation of the shock absorber S is described. In a case where a piston speed is in a low speed region when the piston rod 5 is retracted from the cylinder 4, i.e. during the expansion of the shock absorber S, the first expansion-side leaf valve 2a is kept seated on the valve seat 12 and the expansion-side leaf valves 2a to 2c do not open the expansion-side flow passage 10. The working fluid in the expansion-side chamber L1 pressurized by the piston 1 passes through the orifice formed by the groove 12a and moves to the compression-side chamber L2 through the expansion-side flow passage 10.

Thus, the shock absorber S generates an expansion-side low-speed damping force due to the resistance of the orifice formed by the groove 12a.

When the piston speed increases to be out of the low speed region and reaches a medium/high speed region during the expansion of the shock absorber S, a differential pressure between the expansion-side chamber L1 and the compression-side chamber L2 reaches the valve opening pressure of the expansion-side leaf valves 2a to 2c. As a result, the outer peripheral parts of the expansion-side leaf valves 2a to 2c are deflected toward the opposite piston side to open the expansion-side flow passage 10. Thus, the working fluid in the expansion-side chamber L1 pressurized by the piston 1 passes between the first expansion-side leaf valve 2a and the valve seat 12 and moves to the compression-side chamber L2 through the expansion-side flow passage 10.

As just described, the shock absorber S generates an expansion-side medium/high-speed damping force due to resistance by the expansion-side leaf valves 2a to 2c when the piston speed is in the medium/high speed region. Since the expansion-side leaf valve 2c disposed on the tail end is formed with the rib 3A and has high rigidity, the expansion-side leaf valves 2a to 2c are difficult to open and the expansion-side medium/high-speed damping force can be made larger.

Although the piston speed region is divided into the low-speed region and the medium/high speed region in the above description, threshold values of each region can be arbitrarily set.

Next, functions and effects of the shock absorber S are described. The shock absorber S includes the piston 1 (valve disc) defining the expansion-side chamber L1 and the compression-side chamber L2 (two chambers), the expansion-side flow passage (flow passage) 10 formed in the piston 1 and allowing communication between the expansion-side chamber L1 and the compression-side chamber L2 and the plurality of expansion-side leaf valves (leaf valves) 2a to 2c formed in the shape of annular plates stacked on the piston 1 to openably close the outlet of the expansion-side flow passage 10.

The expansion-side leaf valve (leaf valve) 2c disposed on the tail end stacked on the piston (valve disc) 1 includes the rib 3A recessed on the piston side (valve disc side) and projecting on the opposite piston side (opposite valve disc side).

By forming the rib 3A on the expansion-side leaf valve (leaf valve) 2c disposed on the tail end stacked on the piston (valve disc) 1, initial deflection is not applied to the other expansion-side leaf valves 2a, 2b.

Further, by forming the rib 3A on the expansion-side leaf valve (leaf valve) 2c disposed on the tail end, the rigidity of the leaf valve 2c can be enhanced and the damping force when the piston speed is in the medium/high speed region (expansion-side medium/high-speed damping force in the present embodiment) can be increased.

In this case, although an axial length of the leaf valves as a whole becomes longer by an axial length of the rib 3A, the axial length of the leaf valves as a whole can be suppressed as compared with the case where the damping force when the piston speed is in the medium/high speed region is increased by increasing the number of the stacked leaf valves. Further, since it is possible to reduce the number of the stacked leaf valves, man-hours in assembling the shock absorber S can be reduced.

As just described, by forming the rib 3A on the expansion-side leaf valve 2c disposed on the tail end stacked on the piston 1, the damping force when the piston speed is in the medium/high speed region can be increased without applying initial deflection to the other leaf valves 2a, 2b and the axial length of the leaf valves as a whole can be suppressed.

Further, the rib 3A is formed by press-working in the shock absorber S.

Thus, the rib 3A can be easily and inexpensively formed.

Embodiments of this invention were described above, but the above embodiments are merely examples of applications of this invention, and the technical scope of this invention is not limited to the specific constitutions of the above embodiments.

For example, although the shock absorber S is a shock absorber for automotive vehicle in the above embodiment, it may be a shock absorber for another vehicle or may be a shock absorber other than for vehicle.

Further, in the above embodiment, the shock absorber S is an upright single-cylinder type fluid pressure shock absorber and can compensate for a change of the cylinder interior volume corresponding to the volume of the part of the piston rod inserted into or retracted from the cylinder and a volume change of the working fluid due to a temperature change by the unillustrated gas chamber. Instead of this, the shock absorber S may include a reservoir for storing the working fluid and gas and a base member for partitioning between the reservoir and the compression-side chamber L2, and a change of the cylinder interior volume and a volume change of the working fluid may be compensated for by the reservoir.

Further, in the above embodiment, the leaf valve formed with the rib 3A is the expansion-side leaf valve 2c and stacked on the piston 1 of the shock absorber S. In the case where the shock absorber S includes the base member, the base member may be used as a valve disc and the leaf valve formed with the rib 3A may be stacked on the base member.

Further, the shock absorber S may be a multi-cylinder type shock absorber including an outer tube arranged outside the cylinder 4 and a reservoir formed between the outer tube and the cylinder 4, or a pneumatic shock absorber utilizing air as the working fluid or an inverted shock absorber.

Further, the shapes of the window 11 and the valve seat 12 formed on the piston 1 and the shape of the rib 3A formed on the expansion-side leaf valve 2c disposed on the tail end are not limited to the above ones and can be appropriately selected. For example, two or three circular annular ribs 3A may be formed and arranged to radially overlap. In this case, cracking points can be increased by adding the ribs.

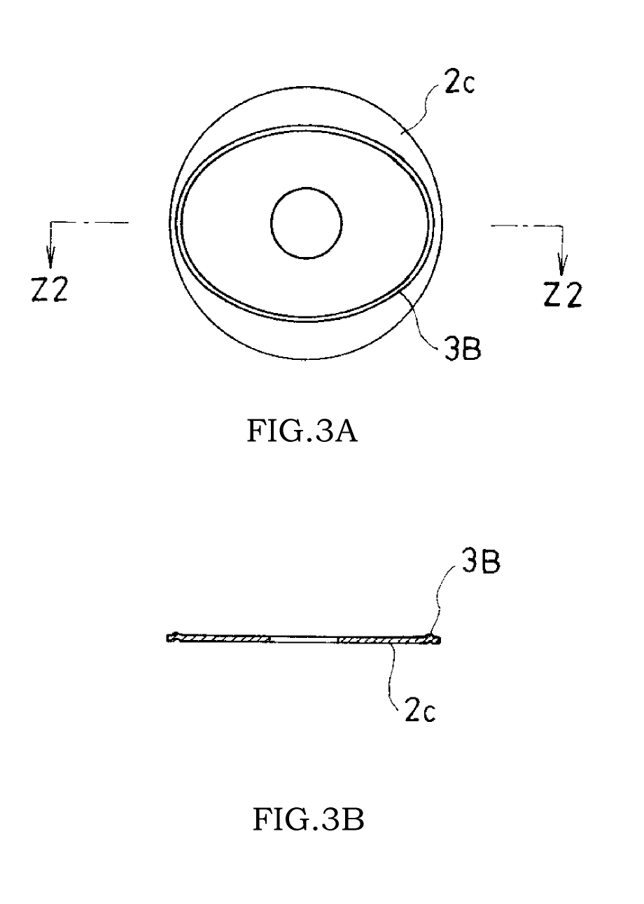

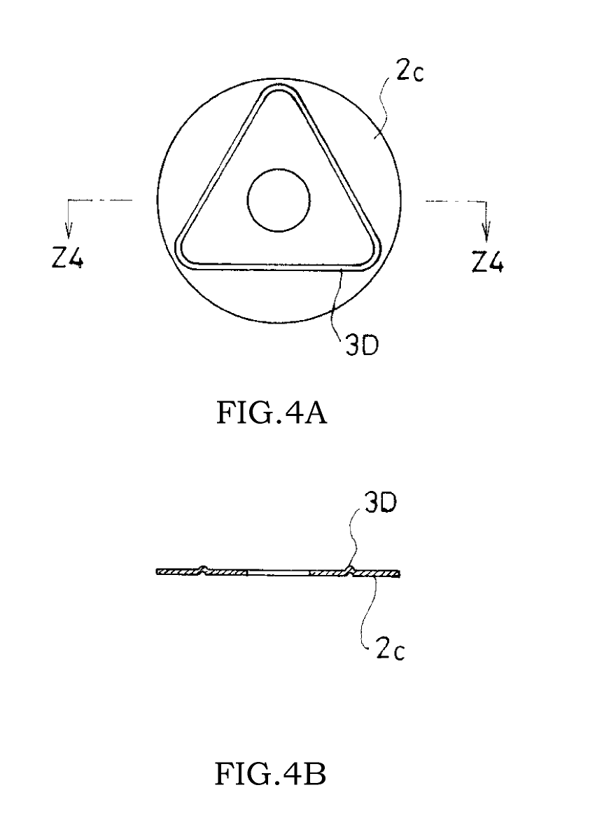

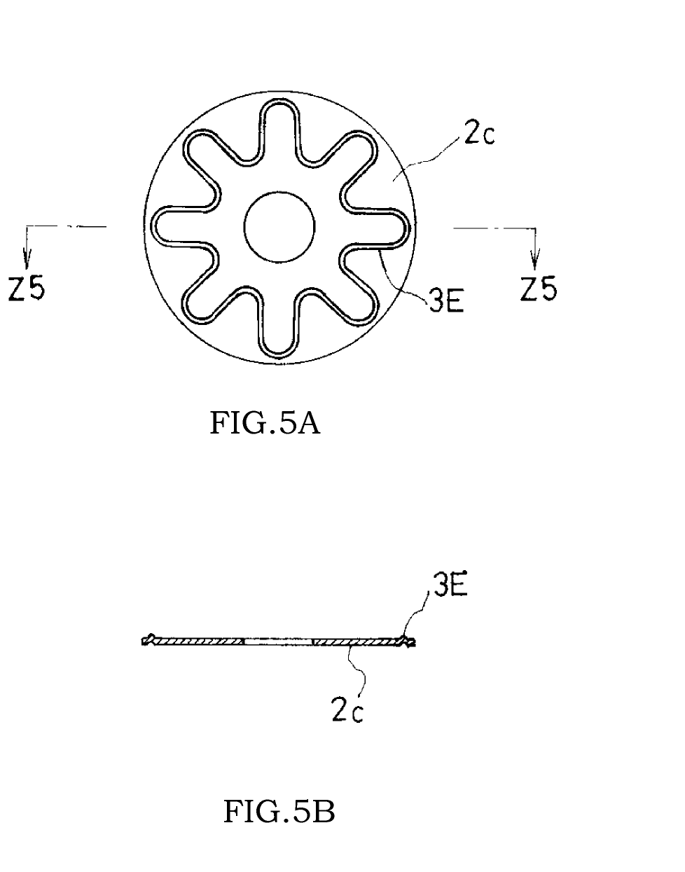

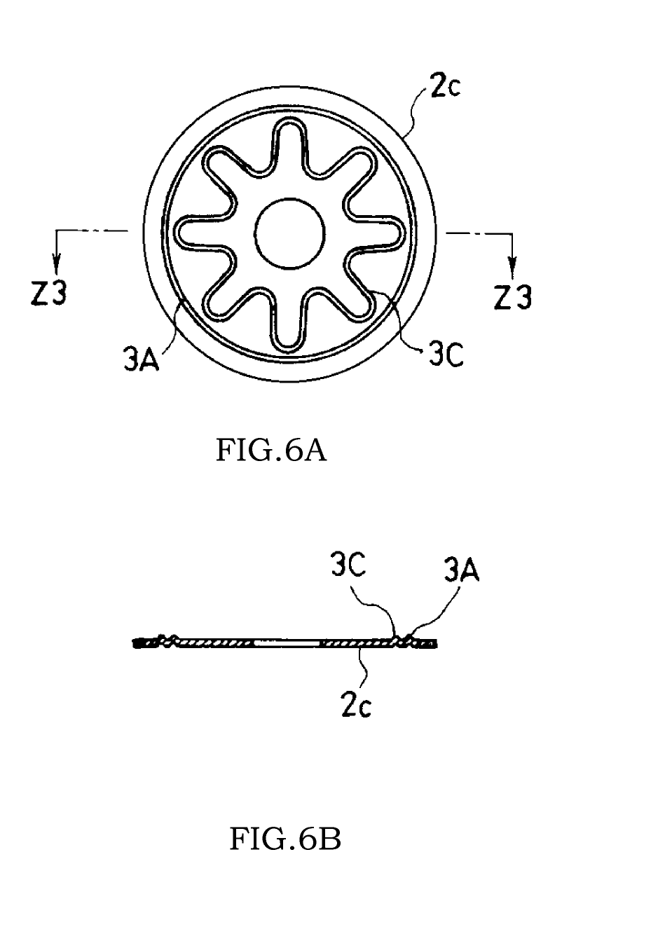

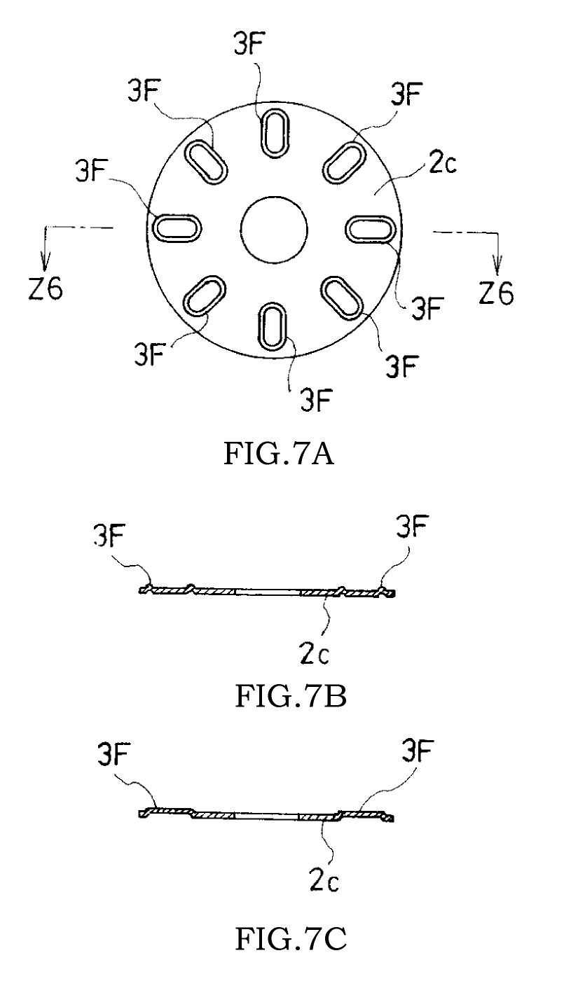

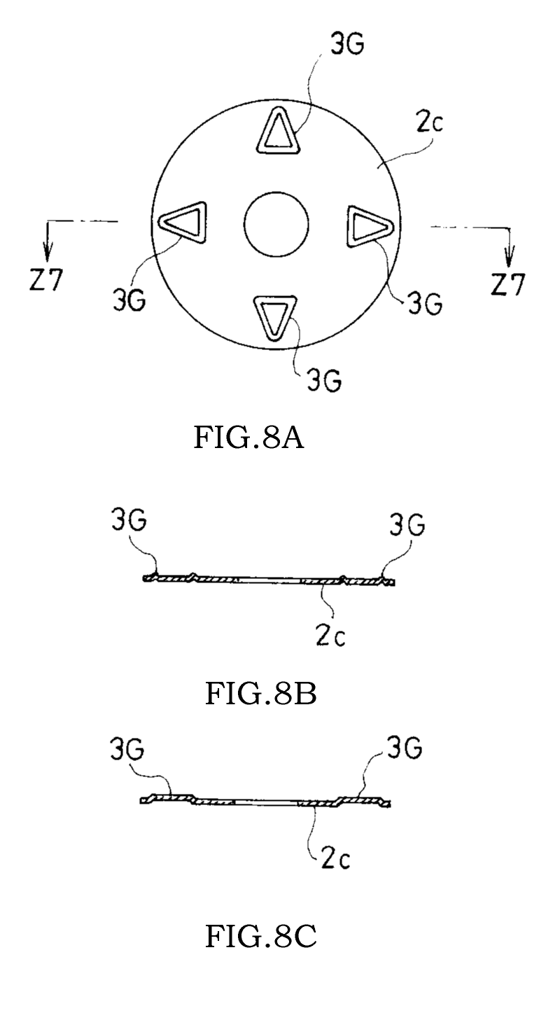

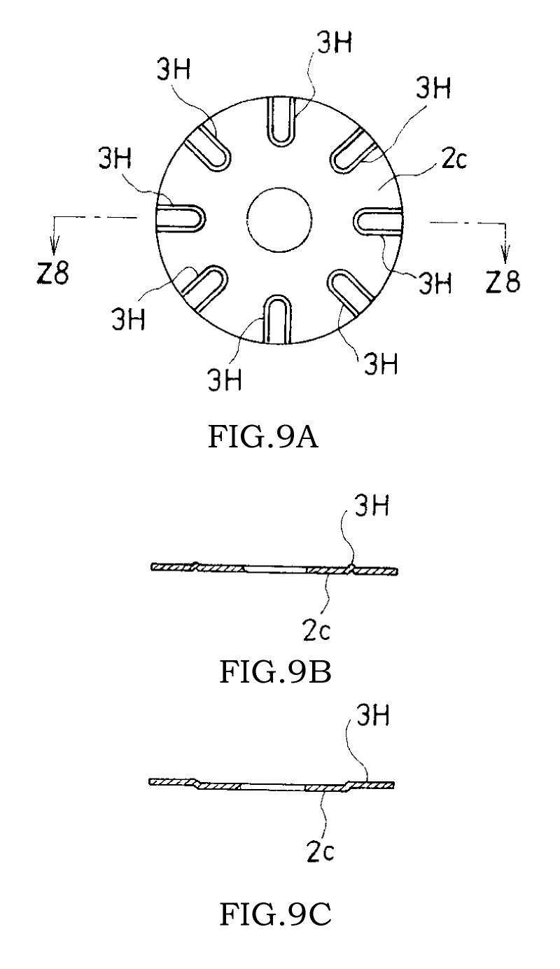

Next, modifications of the rib 3A are shown in FIGS. 3 to 9. A rib 3B shown in FIGS. 3A and 3B is formed into an elliptical ring shape. A rib 3D shown in FIGS. 4A and 4B is formed into a triangular shape. A rib 3E shown in FIGS. 5A and 5B is formed into a petal-like shape. A rib 3C shown in FIGS. 6A and 6B is formed into a petal-like shape and formed inside a circular annular rib 3A. A plurality of ribs 3F shown in FIGS. 7A to 7C are formed into an elliptical shape and provided side by side in a circumferential direction of the expansion-side leaf valve 2c disposed on the tail end. Each rib 3F may be formed as a rib having such a cut surface that only an elliptical outlining part is recessed on the piston side and projecting on the opposite piston side as shown in FIG. 7B or an inner side is also recessed on the piston side and projecting on the opposite piston side as shown in FIG. 7C. A plurality of ribs 3G shown in FIGS. 8A to 8C are formed into a triangular shape and provided side by side in the circumferential direction of the expansion-side leaf valve 2c disposed on the tail end. Each rib 3G may be formed as a rib having such a cut surface that only an outlining part is recessed on the piston side and projecting on the opposite piston side as shown in FIG. 8B or an inner side is also recessed on the piston side and projecting on the opposite piston side as shown in FIG. 8C. A plurality of ribs 3H shown in FIGS. 9A to 9C are formed into a strip shape (U shape) and provided side by side in the circumferential direction of the expansion-side leaf valve 2c disposed on the tail end. Each rib 3H may be formed as a rib having such a cut surface that only an outlining part is recessed on the piston side and projecting on the opposite piston side as shown in FIG. 9B or an inner side is also recessed on the piston side and projecting on the opposite piston side as shown in FIG. 9C. Particularly, when the rib 3C is formed inside the circular annular rib 3A, a damping coefficient (ratio of a damping force change amount to a piston speed change amount) can be increased after the expansion-side leaf valve 2c is opened from an outer peripheral end to the circular annular rib 3A.

Further, the ribs 3A to 3H shown in FIGS. 2A to 9C may be arranged to project toward the piston 1 or be recessed toward the piston 1. Further, the rib formed on the expansion-side leaf valve 2c disposed on the trail end may be formed into a shape obtained by arbitrarily combining the ribs 3A to 3H.

Further, in the above embodiment, only the expansion-side leaf valve 2c disposed on the trail end includes the rib(s) 3A to 3H to enhance the rigidity of the expansion-side leaf valve 2c disposed on the trail end. Contrary to this, the compression-side leaf valve 7c disposed on the trail end may include a rib to increase a compression-side damping force when the piston speed of the shock absorber S is in the medium/high speed region.

This application claims priority based on Japanese Patent Application No. 2013-016881 filed with the Japan Patent Office on Jan. 31, 2013, the entire contents of which are incorporated into this specification.

1. A shock absorber, comprising:
a valve disc defining two chambers;
a flow passage formed in the valve disc, the flow passage allowing communication between the two chambers; and
a plurality of leaf valves formed in the shape of annular plates, the plurality of leaf valves being stacked on the valve disc to openably close an outlet of the flow passage,
wherein:
the leaf valve disposed on the tail end of the plurality of leaf valve stacked on the valve disc includes a rib projecting in an axial direction from one flat surface and recessed on an opposite side; and
each of the leaf valves stacked between the valve disc and the leaf valve disposed on the tail end is formed to have a flat valve disc side end surface and a flat opposite valve disc side end surface.

2. The shock absorber according to claim 1, wherein:
the rib is formed to be recessed on a valve disc side and project on an opposite valve disc side.

3. The shock absorber according to claim 1, wherein:
the rib is formed by press-working.

4. The shock absorber according to claim 1, wherein the rib is formed into an elliptical ring shape.
